(19) United States
(12) Patent Application Publication
(10) Pub. No.: US 2025/0305466 A1
(43) Pub. Date: Oct. 2, 2025

(54) CONTROL DEVICE FOR INTERNAL COMBUSTION ENGINE

(71) Applicant: HONDA MOTOR CO., LTD., Tokyo (JP)

(72) Inventors: Katsuya Matsuura, Wako-shi (JP); Kohtaro Hashimoto, Wako-shi (JP)

(21) Appl. No.: 19/069,473

(22) Filed: Mar. 4, 2025

(30) Foreign Application Priority Data
Mar. 28, 2024 (JP) 2024-053761

(51) Int. Cl. F02D 41/34; F02D 41/30

(52) U.S. Cl. CPC F02D 41/345; F02D 41/3005; F02D 2200/0611

(57) ABSTRACT

Provided is a control device for an internal combustion engine, which is a control device for a spark ignition internal combustion engine, configured to directly inject alcohol-containing fuel into a cylinder, the control device including a controller configured to control injection timing when the fuel is injected into the cylinder from a fuel injection device and ignition timing when the fuel in the cylinder is ignited by a spark; and an ambient temperature detecting part configured to detect an ambient temperature, the controller executing spark ignition of the fuel in a fuel injection period in which the fuel is injected into the cylinder when the ambient temperature is equal to or smaller than a predetermined value.

### CROSS-REFERENCE TO RELATED APPLICATION

Priority is claimed on Japanese Patent Application No. 2024-053761, filed Mar. 28, 2024, the content of which is incorporated herein by reference.

### BACKGROUND OF THE INVENTION

### Field of the Invention

The present invention relates to a control device for an internal combustion engine.

### Description of Related Art

In the related art, efforts to mitigate or reduce the impact of climate change continue, and research and development is being conducted to reduce carbon dioxide emissions to achieve this goal.

In recent years, in spark ignition internal combustion engines (SI engines), attempts have been made to use alcohol-containing fuel as an alternative fuel to gasoline.

For example, Japanese Unexamined Patent Application, First Publication No. H05-340286 proposes a fuel control device for an internal combustion engine configured to control an amount of fuel added at start-up using mixed fuel of alcohol and gasoline. Japanese Unexamined Patent Application, First Publication No. H05-340286 discloses a fuel control device including an alcohol concentration detecting part configured to detect alcohol concentration in mixed fuel, a low boiling point component content detecting means configured to detect a ratio between low boiling point components of gasoline in the mixed fuel, and an increase correction means configured to increase and correct a fuel injection volume when the ratio between the low boiling point components of the gasoline is decreased when the alcohol concentration is equal to or greater than a predetermined value.

In addition, Japanese Unexamined Patent Application, First Publication No. 2020-180550 proposes a control device for an internal combustion engine configured to use fuel containing alcohol and directly inject the fuel into a cylinder. Japanese Unexamined Patent Application, First Publication No. 2020-180550 discloses a control device including an engine temperature parameter acquisition means configured to acquire an engine temperature parameter representing a temperature of an internal combustion engine, an alcohol concentration acquisition means configured to acquire an alcohol concentration in fuel, a load acquisition means configured to acquire a load of the internal combustion engine, and a controller configured to select one of intake stroke injection of injecting fuel in an intake stroke and compression stroke injection of injecting fuel in a compression stroke as a fuel injection mode and execute the selected one according to the acquired engine temperature parameter, alcohol concentration and internal combustion engine load after cold start of the internal combustion engine.

### SUMMARY OF THE INVENTION

Alcohols such as methanol, ethanol, and the like, are difficult to vaporize at temperatures below their boiling points, and have a greater latent heat of vaporization than gasoline. For this reason, in the spark ignition internal combustion engine configured to directly inject fuel into the cylinder, when alcohol-containing fuel is used, compared to a case in which gasoline is used as fuel, starting failure is more likely to occur under a low temperature environment. For this reason, there has been a demand for improved startability under low temperature environments for spark ignition internal combustion engines, which inject alcohol-containing fuel directly into a cylinder.

An aspect of the present application is directed to providing a control device for an internal combustion engine capable of obtaining good startability even when a spark ignition internal combustion engine configured to directly inject alcohol-containing fuel into a cylinder is started under a low temperature environment.

An aspect of the present application provides the following means.

A control device for an internal combustion engine of a first aspect of the present invention is a control device for a spark ignition internal combustion engine (3) configured to directly inject alcohol-containing fuel into a cylinder (3a), the control device including a controller (2) configured to control injection timing when the fuel is injected into the cylinder (3a) from a fuel injection device (4) and ignition timing when the fuel in the cylinder (3a) is ignited by a spark; and an ambient temperature detecting part (20) configured to detect an ambient temperature, wherein the controller (2) executes spark ignition of the fuel in a fuel injection period in which the fuel is injected into the cylinder (3a) when the ambient temperature is equal to or smaller than a predetermined value.

In the control device for an internal combustion engine of the first aspect, the controller executes the spark ignition of the fuel in the fuel injection period in which the alcohol-containing fuel is injected into the cylinder when the ambient temperature is equal to or smaller than the predetermined value. For this reason, even when the spark ignition internal combustion engine configured to directly inject the alcohol-containing fuel into the cylinder is started under a low temperature environment of a predetermined ambient temperature or less, good startability is obtained.

According to a control device for an internal combustion engine of a second aspect of the present invention, in the first aspect, the ambient temperature detecting part (20) has: an outside temperature detecting part (22) configured to detect a temperature of outside air suctioned into the cylinder (3a); and an engine water temperature detecting part (23) configured to detect a temperature of engine water, wherein the ambient temperature is the temperature of the outside air and/or the temperature of the engine water.

In the control device for an internal combustion engine of the second aspect, the controller executes the spark ignition of the fuel in the fuel injection period when the temperature of the outside air, which is an ambient temperature, and/or the temperature of the engine water are equal to or smaller than the predetermined value. For this reason, by executing the spark ignition of the fuel in the fuel injection period, the effect of improving startability of the internal combustion engine can be more effectively obtained.

According to a control device for an internal combustion engine of a third aspect of the present invention, in the first aspect, the controller (2) executes spark ignition of the fuel in the fuel injection period when the ambient temperature is within a range of 5° C. to −40° C.

When the internal combustion engine is started under a low temperature environment in which the ambient temperatures such as the temperature of the outside air and/or the temperature of the engine water are equal to or smaller than 5° C., a starting failure in the internal combustion engine is more likely to occur. In addition, when the internal combustion engine is started under a low temperature environment in which the ambient temperature is equal to or lower than −40° C., the spark ignition of the fuel during the fuel injection period tends to improve the startability of the internal combustion engine. In the control device for an internal combustion engine of the third aspect, the controller executes the spark ignition of the fuel in the fuel injection period when the ambient temperature is within a range of 5° C. to −40° C. For this reason, by executing the spark ignition of the fuel in the fuel injection period, the effect of improving startability of the internal combustion engine becomes more significant.

According to a control device for an internal combustion engine of a fourth aspect of the present invention, in the first aspect, an alcohol concentration detecting part (24) configured to detect a content of alcohol contained in the fuel is provided, and the controller (2) executes spark ignition of the fuel in the fuel injection period when the concentration of alcohol in the fuel is equal to or greater than a predetermined value.

As the concentration of alcohol in the fuel increases, a starting failure under a low temperature environment is more likely to occur. For this reason, when the ambient temperature is equal to or smaller than the predetermined value, the effect of improving startability of the internal combustion engine by executing the spark ignition of the fuel in the fuel injection period becomes more significant as the concentration of alcohol in the fuel increases. In the control device for an internal combustion engine of the fourth aspect, the controller executes the spark ignition of the fuel in the fuel injection period when the concentration of alcohol in the fuel is equal to or greater than the predetermined value. For this reason, by executing the spark ignition of the fuel in the fuel injection period, the effect of improving startability of the internal combustion engine can be more effectively obtained.

According to a control device for an internal combustion engine of a fifth aspect of the present invention, in the fourth aspect, the controller (2) executes spark ignition of the fuel in the fuel injection period when a concentration of alcohol in the fuel is equal to or greater than 90 volume %.

In the control device for an internal combustion engine of the fifth aspect, the controller executes the spark ignition of the fuel in the fuel injection period when the concentration of alcohol in the fuel is equal to or greater than 90 volume %. For this reason, by executing the spark ignition of the fuel in the fuel injection period, the effect of improving startability of the internal combustion engine becomes more remarkable. In addition, when the alcohol-containing fuel has a concentration of alcohol in the fuel of equal to or greater than 90 volume %, it is preferable as an alternative fuel to gasoline. According to a control device for an internal combustion engine of a sixth aspect of the present invention, in the first aspect, a crank angle detecting part (21) configured to detect rotation of a crankshaft (3e) and output a crank angle signal and a top dead center signal is provided, and the controller (2) injects the fuel into the cylinder (3a) from the fuel injection device (4) in a compression stroke.

In the control device for an internal combustion engine of the sixth aspect, the controller injects fuel into the cylinder from the fuel injection device in the compression stroke. In this case, in a state in which the fuel injection period becomes the compression stroke, the pressure in the cylinder becomes high, and the fuel becomes likely to vaporize, but the decrease in mass average temperature caused by the latent heat of vaporization is suppressed, the effect of improving startability of the internal combustion engine becomes more remarkable by executing the spark ignition of the fuel in the fuel injection period.

According to a control device for an internal combustion engine of a seventh aspect of the present invention, in the first aspect, the controller (2) executes spark ignition of the fuel in a ⅓ period of retardation in the fuel injection period.

In the ⅓ of a period of retardation in the fuel injection period, there is a state in which the pressure in the cylinder becomes higher, the fuel is more likely to vaporize, but the decrease in mass average temperature caused by the latent heat of vaporization is suppressed. For this reason, by executing the spark ignition of the fuel in the ⅓ period of retardation in the fuel injection period, the effect of improving startability of the internal combustion engine can be more effectively obtained.

According to a control device for an internal combustion engine of an eighth aspect of the present invention, in the first aspect, a cylinder pressure detecting part configured to detect a pressure in the cylinder (3a) is provided, and the controller (2) determines whether the fuel has been ignited on the basis of a change in pressure in the cylinder (3a) and executes spark ignition of the fuel in the fuel injection period when a consecutive number of the fuel ignition cycles is equal to or smaller than a predetermined value.

The spark ignition of the alcohol-containing fuel during the fuel injection period in which the fuel is injected into the cylinder improves the startability of the internal combustion engine when the ambient temperature is equal to or smaller than the predetermined value. However, after starting of the internal combustion engine, in order to secure a more stable combustion state, it may be preferable to execute the spark ignition of the fuel at a timing other than during the fuel injection period. In the control device for an internal combustion engine of the eighth aspect, the controller determines whether the fuel is ignited on the basis of the change in pressure in the cylinder (3a), and executes the spark ignition of the fuel in the fuel injection period when a consecutive number (number of ignitions) of the fuel ignition cycles is equal to or smaller than the predetermined value. For this reason, by executing the spark ignition of the fuel during the fuel injection period, the startability of the internal combustion engine can be sufficiently improved and a more stable combustion state can be easily secured after the internal combustion engine starts.

According to a control device for an internal combustion engine of a ninth aspect of the present invention, in the first aspect, a crank angle detecting part (21) configured to detect rotation of a crankshaft (3e) and output a crank angle signal is provided, and the controller (2) determines whether the fuel is ignited on the basis of the change in crank angle, and executes spark ignition of the fuel in the fuel injection period when a consecutive number of the fuel ignition cycles is equal to or smaller than a predetermined value.

In the control device for an internal combustion engine of the ninth aspect, the controller determines whether the fuel is ignited on the basis of the change in crank angle and executes the spark ignition of the fuel in the fuel injection period when the consecutive number (number of ignitions) of fuel ignition cycles is equal to or smaller than the predetermined value. For this reason, by executing the spark ignition of the fuel in the fuel injection period, the startability of the internal combustion engine can be sufficiently improved, and a more stable combustion state after starting of the internal combustion engine is easily secured.

In the control device of the present invention, the controller executes the spark ignition of the fuel in the fuel injection period in which the alcohol-containing fuel is injected into the cylinder when the ambient temperature is equal to or smaller than the predetermined value. For this reason, even when the spark ignition internal combustion engine configured to directly inject the alcohol-containing fuel into the cylinder is started under a low temperature environment, good startability can be obtained.

### BRIEF DESCRIPTION OF THE DRAWINGS

FIG. 1 is a schematic diagram for describing an internal combustion engine controlled by a control device for an internal combustion engine according to the embodiment, and the control device.

FIG. 2 is a flowchart for describing control processing of an engine executed by the control device of the embodiment.

FIG. 3 is a graph showing a relationship between a crank angle and a cylinder pressure when the engine is operated under a low temperature environment.

FIG. 4 is a graph showing a relationship between a crank angle and a ratio of fuel vaporized in a cylinder when the engine is operated under a low temperature environment.

FIG. 5 is a graph showing a relationship between a crank angle and a mass average temperature in the cylinder when the engine is operated under a low temperature environment.

FIG. 6 is a graph showing a relationship between a crank angle and an output upon spark ignition when the engine is operated under a low temperature environment.

FIG. 7 is a graph showing a relationship between a crank angle and an output upon spark ignition when the engine is operated under a low temperature environment.

### DETAILED DESCRIPTION OF THE INVENTION

The present inventor(s) has conducted extensive research into the relationship between characteristics of alcohol-containing fuels and timing of spark ignition of alcohol-containing fuels in order to improve startability of internal combustion engines under low temperature environments.

In general, in the spark ignition internal combustion engine configured to directly inject gasoline into a cylinder, no spark ignition occurs during a fuel injection period when the gasoline is injected into the cylinder. This is because the gasoline sprayed into the cylinder wets the ignition plug, making it difficult to produce a spark; this is known as plug fouling, making it difficult for the gasoline to ignite and reducing startability.

However, the present inventor(s) discovered that in a spark ignition internal combustion engine in which alcohol-containing fuel is directly injected into a cylinder, by spark-igniting the fuel during the fuel injection period in which the fuel is injected into the cylinder, startability under a low temperature environment is improved compared to the case of spark ignition of the fuel at a timing other than the fuel injection period, and thus came up with the present invention.

Hereinafter, a control device for an internal combustion engine of the embodiment will be described in detail with reference to the accompanying drawings as appropriate. The drawings used in the following description may show enlarged characteristic parts for the sake of convenience in order to make the features of the present invention easier to understand. Accordingly, dimensional proportions of each component may differ from the actual ones. Materials, dimensions, and the like, exemplified in the following description are merely examples, and the present invention is not limited to them, and can be modified as appropriate within the scope that does not change the scope of the invention.

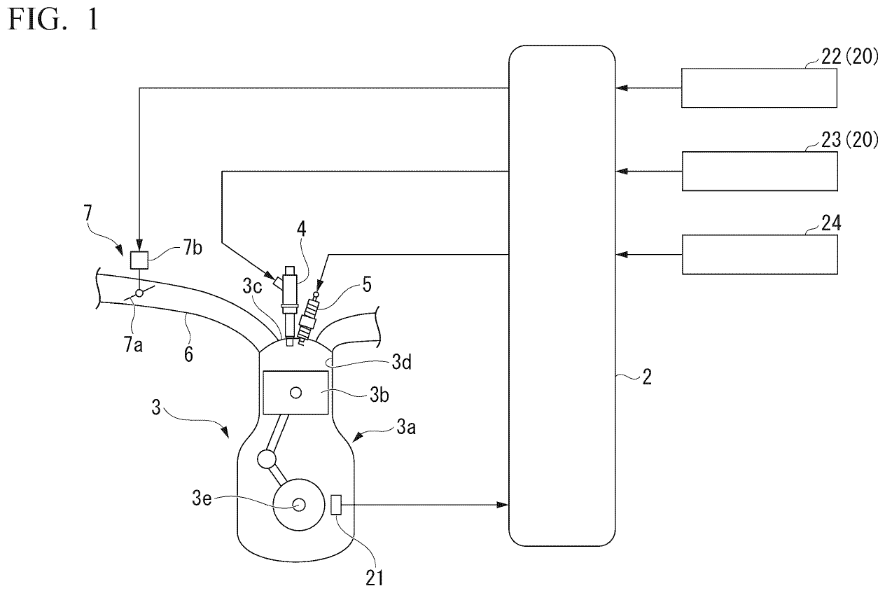

FIG. 1 is a schematic diagram for describing an internal combustion engine controlled by a control device for an internal combustion engine according to an embodiment, and the control device. In the embodiment, a case in which the control device for an internal combustion engine of the embodiment is applied as a control device configured to control an engine 3 shown in FIG. 1, which is an example of an internal combustion engine, will be described exemplarily.

The engine 3 (internal combustion engine) shown in FIG. 1 is a spark ignition internal combustion engine configured to directly inject alcohol-containing fuel into a cylinder 3a. The engine 3 can be mounted in, for example, a vehicle (not shown).

The alcohol contained in the alcohol-containing fuel may be, for example, one or more types of alcohol selected from methanol, ethanol, propanol, butanol, and the like. Among the above, it is preferable that the alcohol contained in the alcohol-containing fuel is methanol and/or ethanol. This is because by controlling the engine 3 using the control device of this embodiment, the startability of the engine 3 can be significantly improved.

The alcohol-containing fuel may be either alcohol alone or contain both alcohol and non-alcoholic compounds. It may be included in fuel containing alcohol. Compounds other than alcohol that may be contained in the alcohol-containing fuel include non-alcohol fuels such as gasoline, impurities such as water, and additives.

When the alcohol-containing fuel contains both alcohol and a non-alcohol compound, the concentration of alcohol in the fuel is preferably equal to or greater than 90 volume %, and more preferably equal to or greater than 95 volume %.

The engine 3 is, for example, a 4-cylinder engine having four cylinders 3a (only one is shown in FIG. 1). A combustion chamber 3d is provided between a piston 3b and a cylinder head 3c of each of the cylinders 3a. The cylinder head 3c is provided with a fuel injection device 4 and an ignition plug 5 for each of the cylinders 3a. In the engine 3 shown in FIG. 1, fuel is directly injected into the cylinder 3a from the fuel injection device 4.

As shown in FIG. 1, the fuel injection device 4 and the ignition plug 5 are electrically connected to a controller 2 of the control device of the embodiment. The injection timing and injection volume of the fuel injected from the fuel injection device 4 into the cylinder 3a, and the ignition timing of the spark ignition of the fuel in the cylinder 3a are controlled by a control signal from the controller 2.

As shown in FIG. 1, an intake passage 6 is connected to the cylinder head 3c of each of the cylinders 3a. The intake passage 6 is provided with a throttle valve 7. The throttle valve 7 has a butterfly type valve body 7a, and an actuator 7b configured to drive the valve body 7a. The actuator 7b is electrically connected to the controller 2 and driven by a control signal from the controller 2. Accordingly, an opening angle of the valve body 7a is controlled, and a volume of air drawn into the cylinder 3a is controlled.

The control device of the embodiment includes a crank angle detecting part 21, an ambient temperature detecting part 20 configured to detect an ambient temperature, an alcohol concentration detecting part 24, and a cylinder pressure detecting part (not shown). As shown in FIG. 1, each of these detecting parts (sensors) is electrically connected to the controller 2. Output signals output from these detecting parts are input to the controller 2.

In the embodiment, an outside temperature detecting part 22 and an engine water temperature detecting part 23 are provided as the ambient temperature detecting part 20. The control device of the embodiment may have both or any one of the outside temperature detecting part 22 and the engine water temperature detecting part 23 as the ambient temperature detecting part 20.

In addition, while the case in which the ambient temperature detecting part 20 is provided has been exemplarily described in the embodiment, the alcohol concentration detecting part 24 may not be provided.

The crank angle detecting part 21 detects rotation of a crankshaft 3e of the engine 3 and outputs a crank angle (CRK) signal and a top dead center (TDC) signal.

The outside temperature detecting part 22 detects a temperature of air flowing through the intake passage 6 as a temperature of outside air suctioned into the cylinder 3a.

The engine water temperature detecting part 23 detects a temperature of engine water, which is a temperature of cooling water that circulates in a cylinder block of the engine 3.

The alcohol concentration detecting part 24 detects an alcohol content contained in the fuel by a known method. The alcohol concentration detecting part 24 is installed in, for example, a pipeline configured to connect the fuel injection device 4 and a fuel tank (not shown).

The cylinder pressure detecting part (not shown) is installed in the cylinder 3a and detects a pressure in the cylinder 3a by a known method.

As the controller 2, for example, an electronic control unit (ECU) can be used. The controller 2 is configured by a microcomputer constituted by a CPU, a RAM, a ROM, an E2PROM, an I/O interface, and the like. The controller 2 executes various engine control processings according to a control program stored in the ROM on the basis of the signal or the like input from the detecting means (sensor).

The controller 2 calculates the output acquired by combusting the fuel on the basis of a change in pressure in the cylinder 3a detected by the cylinder pressure detecting part (not shown).

The controller 2 of the control device of the embodiment controls injection timing when fuel is injected into the cylinder 3a from the fuel injection device 4 and ignition timing when fuel in the cylinder 3a is ignited by a spark. It is preferable that the controller 2 in the embodiment applies spark ignition of the fuel once per cycle.

The controller 2 executes spark ignition of the fuel during the fuel injection period in which the fuel is injected into the cylinder 3a when the ambient temperature is equal to or lower than the predetermined value. The ambient temperature in the embodiment may be any one of the temperature of the outside air and the temperature of the engine water, or may be both the temperature of the outside air and the temperature of the engine water.

When the ambient temperature in the embodiment is both the temperature of the outside air and the temperature of the engine water, the predetermined value of the temperature of the outside air and the predetermined value of the temperature of the engine water may be the same or different.

The predetermined value of the ambient temperature in the embodiment can be determined according to use of the engine 3 or the like as appropriate. The predetermined value of the ambient temperature in this embodiment is preferably 5° C. or less, which is the temperature at which starting failure of the engine 3 is more likely to occur, or may be 0° C. or less. The lower limit of the predetermined value of the ambient temperature can be, for example, −40° C. or higher.

It is preferable that the controller 2 executes spark ignition of the fuel during the fuel injection period when the ambient temperature is equal to or smaller than the predetermined value and the concentration of alcohol in the fuel is equal to or greater than the predetermined value. This is because the effect of improving the startability of engine 3 becomes more remarkable by spark-igniting the fuel during the fuel injection period. The predetermined value of the concentration of alcohol in the fuel in this embodiment can be appropriately determined depending on the use of the engine 3 or the like. The predetermined value of the concentration of alcohol in the fuel in this embodiment is preferably 90 volume % or more, more preferably 95 volume % or more, and thus, the higher the alcohol concentration, the better.

It is preferable that the controller 2 executes injection of fuel into the cylinder 3a from the fuel injection device 4 in the compression stroke when the ambient temperature is equal to or lower than the predetermined value. In this case, the fuel injection period is the compression stroke.

It is preferable that the controller 2 executes spark ignition within a period that is ⅓ of retardation of the fuel injection period when the ambient temperature is equal to or lower than the predetermined value.

In addition, it is preferable that the controller 2 determines whether the fuel is ignited on the basis of a change in pressure in the cylinder 3a detected by the cylinder pressure detecting part (not shown), and executes the spark ignition of the fuel within the fuel injection period even in the next cycle when a consecutive number (number of ignitions) of fuel ignition cycles (cycles in which fuel is successfully ignited and combusted) is equal to or smaller than a predetermined number. The predetermined value of the consecutive number of fuel ignition cycles may be 3 or less, or may be 2 or less.

In addition, the controller 2 may determine whether the fuel is ignited on the basis of the change in crank angle detected by the crank angle detecting part 21, and may execute spark ignition of the fuel within the fuel injection period even in the next cycle when the consecutive number (number of ignitions) of fuel ignition cycles (cycles in which the fuel is successfully ignited and combusted).

In addition, the controller 2 may determine whether the fuel is ignited on the basis of the change in pressure in the cylinder 3a and the change in crank angle.

Even in these cases, the predetermined value of the consecutive number of fuel ignition cycles is preferably 3 or less, and may be 2 or less.

Next, control processing of the engine 3 by the control device of the embodiment will be described.

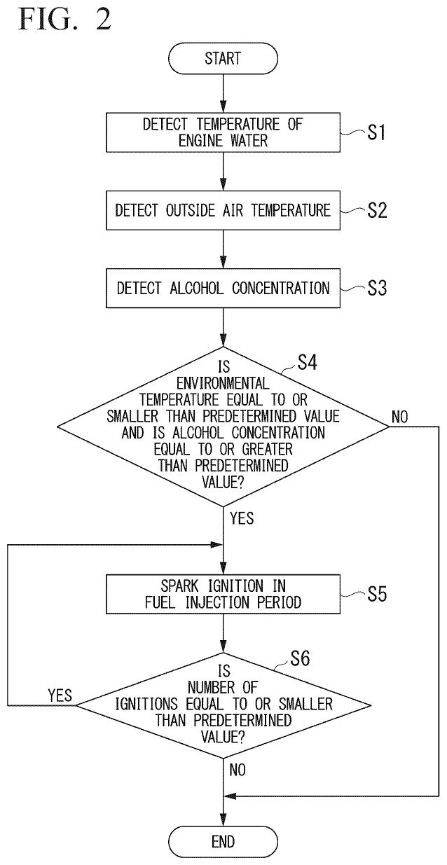

FIG. 2 is a flowchart for describing control processing of the engine 3 executed by the control device of the embodiment.

In the embodiment, first, the controller 2 causes the engine water temperature detecting part 23 to detect a temperature of engine water (step S1). Next, the controller 2 causes the outside temperature detecting part 22 to detect a temperature of outside air suctioned into the cylinder 3a (step S2). Next, the controller 2 causes the alcohol concentration detecting part 24 to detect alcohol content contained in the fuel (step S3).

Next, the controller 2 determines whether each of the temperature of the outside air, which is an ambient temperature, and the temperature of the engine water is equal to or smaller than the predetermined value, and whether the concentration of alcohol in the fuel is equal to or greater than the predetermined value (step S4).

Then, when it is determined that both the temperature of the outside air and the temperature of the engine water are equal to or lower than the predetermined value and the concentration of alcohol in the fuel is equal to or greater than the predetermined value, as shown in FIG. 2, the processing advances to step S5, and the controller 2 executes spark ignition of the fuel within the fuel injection period (step S5).

Meanwhile, when any one or more of the following conditions is met: the temperature of the outside air exceeds the predetermined value, the temperature of the engine water exceeds the predetermined value, and the concentration of the alcohol in the fuel is less than the predetermined value (in other words, when any one or more of the temperature of the outside air, the temperature of the engine water, and the concentration of alcohol in the fuel are outside the specified numerical range), the control processing by the control device of this embodiment ends.

In step S5, it is preferable that the controller 2 executes the spark ignition of the fuel in the fuel injection period when the temperature of the outside air and/or the engine water is within a range of 5° C. to −40° C. In step S5, it is preferable that the controller 2 executes the spark ignition of the fuel in the fuel injection period when the concentration of alcohol in the fuel is equal to or greater than 90 volume %.

It is preferable that the controller 2 executes fuel injection into the cylinder 3a from the fuel injection device 4 in the compression stroke in step S5 when both the temperature of the outside air and the temperature of the engine water are equal to or smaller than the predetermined value and the concentration of alcohol in the fuel is equal to or greater than the predetermined value in step S4.

In addition, it is preferable that the controller 2 executes the spark ignition of the fuel in a ⅓ period of retardation in the fuel injection period in step S5 when both the temperature of the outside air and the temperature of the engine water are equal to or smaller than the predetermined value and the concentration of alcohol in the fuel is equal to or greater than the predetermined value.

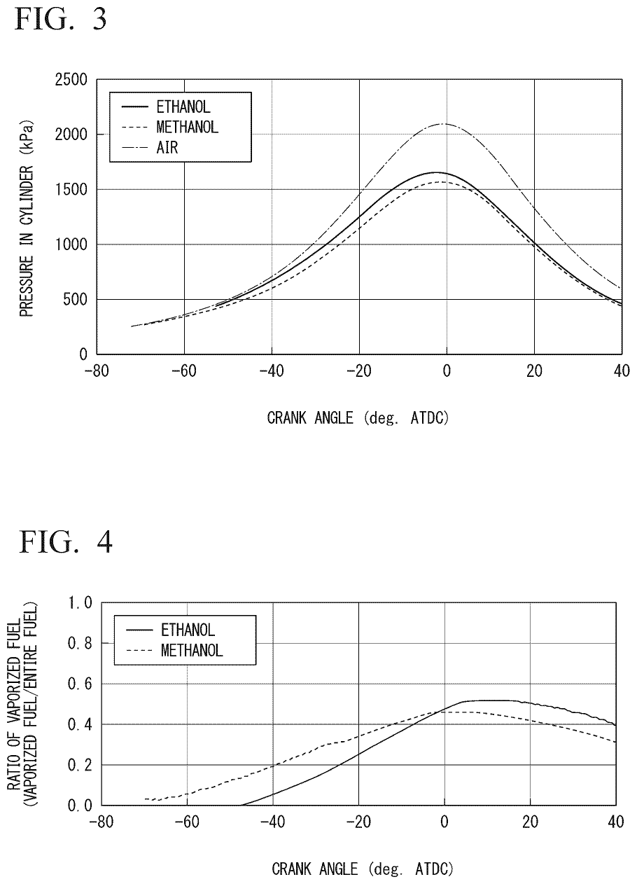

Here, a state in the cylinder when the engine in which the alcohol-containing fuel is directly injected into the cylinder is operated under a low temperature environment will be described. FIG. 3 to FIG. 5 are graphs showing states in the cylinder when the engine is operated under operating conditions: engine rotation number; 1100 rpm, intake pipe pressure; throttle opening angle fully open, temperature of engine water; 0° C., temperature of outside air suctioned into cylinder; 20° C., fuel pressure; 16 MPa, and fuel injection volume; 3 times of stoichiometric air-fuel ratio. As the fuel, only methanol or only ethanol was used.

The fuel injection period of the methanol was a range of crank angle −70 deg. ATDC to 0 deg. ATDC. The fuel injection period of the ethanol was a range of crank angle −50 deg. ATDC to 0 deg. ATDC. That is, even in the case in which the fuel is methanol or ethanol, the fuel was injected into the cylinder from the fuel injection device in the compression stroke.

FIG. 3 is a graph showing a relationship between a crank angle and a cylinder pressure (pressure in combustion chamber) when the engine is operated under a low temperature environment. FIG. 3 shows an air pressure in the cylinder together with a methanol and ethanol pressure in the cylinder. The cylinder pressure (pressure in combustion chamber) in FIG. 3 was measured by a pressure sensor that is a cylinder pressure detecting part.

As shown in FIG. 3, even when the fuel is methanol or ethanol, the cylinder pressure is highest in the vicinity of the compression top dead center (crank angle 0 deg. ATDC).

FIG. 4 is a graph showing a relationship between a crank angle and a ratio of fuel vaporized in the cylinder (combustion chamber) when the engine is operated under a low temperature environment. The ratio of the vaporized fuel (vaporized fuel/entire fuel) in FIG. 4 was measured by the following method.

That is, the amount of the vaporized fuel was calculated by assuming that the difference in pressure between the pressure in cylinder when the gas in the cylinder is air only (in other words, when no fuel was injected) and the pressure in cylinder when the fuel was injected was caused by the latent heat of vaporization of the fuel. After that, the ratio of the amount of the vaporized fuel with respect to the amount of fuel injected into the cylinder (the entire fuel) was obtained using the amount of the vaporized fuel calculated in this way.

As shown in FIG. 4, even when the fuel is methanol or ethanol, the ratio of the vaporized fuel (vaporized fuel/entire fuel) is increased as the crank angle approaches the compression top dead center (0 deg. ATDC) from starting of the fuel injection, and about half of the fuel in the cylinder is vaporized in the vicinity of the compression top dead center.

When the fuel is ethanol, the ratio of the vaporized fuel (vaporized fuel/entire fuel) is further increased after ending (crank angle 0 deg. ATDC) of the fuel injection, is highest when the crank angle is about 10 deg. ATDC, and then, is gradually decreased.

Meanwhile, when the fuel is methanol, the ratio of the vaporized fuel (vaporized fuel/entire fuel) is highest as the crank angle is near the compression top dead center (0 deg. ATDC), and then, is gradually decreased.

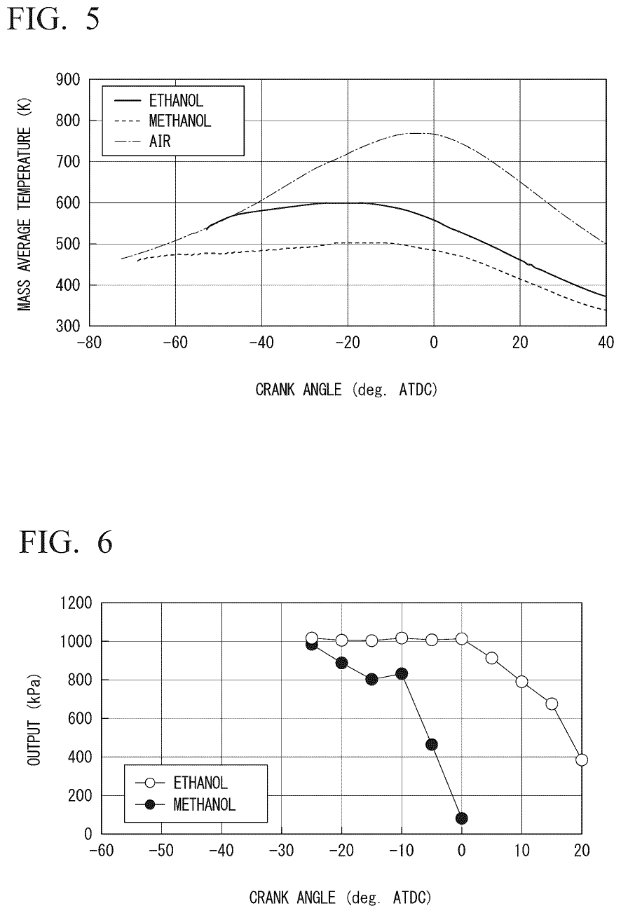

FIG. 5 is a graph showing a relationship between a crank angle and a mass average temperature in the cylinder (combustion chamber) when the engine is operated under a low temperature environment. FIG. 5 shows a mass average temperature of air in the cylinder together with a mass average temperature of methanol and ethanol in the cylinder. The mass average temperature in FIG. 5 was calculated using a measured value of the pressure in the cylinder.

As shown in FIG. 5, even when the fuel is methanol or ethanol, the mass average temperature is gradually increased by starting of the fuel injection, is highest when the crank angle is about −20 deg. ATDC, is gradually decreased as it approaches the compression top dead center (0 deg. ATDC) from about crank angle −10 deg. ATDC, and is largely decreased after ending of the fuel injection. This change is due to the large latent heat of vaporization of methanol and ethanol.

As shown in FIG. 5, when the engine is operated under a condition of a low temperature environment, the mass average temperature in the cylinder is higher for the fuel injection period in which methanol or ethanol is injected into the cylinder compared to any timing other than the fuel injection period. The characteristic change in mass average temperature, which is specific to the use of such alcohol-containing fuel, has a greater effect on the ignition ability of the fuel than the increase in the ratio of vaporized fuel after ending of the fuel injection as shown in FIG. 4. For this reason, in the embodiment, it is estimated that better startability can be obtained by the spark ignition of the fuel during the fuel injection period compared to the spark ignition of the fuel at the timing other than the fuel injection period.

Further, when the fuel injection period is the compression stroke, during the fuel injection period, the pressure in the cylinder is high as shown in FIG. 3, the fuel is likely to vaporize as shown in FIG. 4, and the drop in mass average temperature caused by the latent heat of vaporization is suppressed as shown in FIG. 5. For this reason, by executing the spark ignition of the fuel during the fuel injection period, the effect of improving engine startability can be obtained more effectively.

In addition, as shown in FIG. 3 to FIG. 5, during the ⅓ period of retardation of the fuel injection period, the pressure in the cylinder is higher, the fuel is more likely to vaporize, and the decrease in mass average temperature due to the latent heat of vaporization is suppressed, resulting in a higher mass average temperature. For this reason, by executing the spark ignition of the fuel within ⅓ of the retardation angle of the fuel injection period, the effect of improving engine startability becomes more remarkable.

Next, the relationship between the crank angle and the output when the engine is operated under the same operating conditions as in FIG. 3 to FIG. 5 and the spark ignition is executed at the timing when the crank angle was varied by 5 deg. ATDC will be described.

FIG. 6 is a graph showing a relationship between the crank angle and the output upon the spark ignition when the engine is operated under a low temperature environment. The output in FIG. 6 was calculated on the basis of the change in pressure in the cylinder.

As shown in FIG. 6, even when the fuel is methanol or ethanol, by executing the spark ignition during the fuel injection period (methanol; −70 deg. ATDC to 0 deg. ATDC, ethanol; −50 deg. ATDC to 0 deg. ATDC) , the ignition is confirmed, and good startability is obtained.

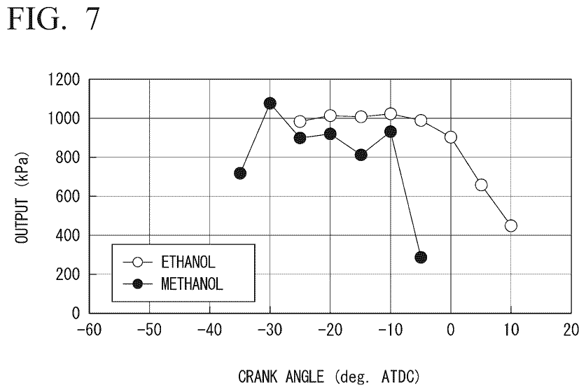

FIG. 7 is a graph showing a relationship between a crank angle and an output upon spark ignition when the engine is operated under a low temperature environment. FIG. 7 shows an example with the same conditions as FIG. 6, except that the fuel injection period of methanol is in the range of crank angle −80 deg. ATDC to −10 deg. ATDC and the fuel injection period of ethanol is in the range of crank angle −60 deg. ATDC to −10 deg. ATDC. The output in FIG. 7 was measured by the same method as in FIG. 6.

As shown in FIG. 7, even when the fuel is methanol or ethanol, even if the fuel injection was ended (10 deg. ATDC) before the crank angle reaches the compression top dead center (0 deg. ATDC), ignition was confirmed by the spark ignition within the fuel injection period, and good startability was obtained.

Returning to FIG. 2, the controller 2 that executed step S5 determines whether the fuel is ignited on the basis of the change in pressure in the cylinder 3a, calculates a consecutive number (number of ignitions) of fuel ignition cycles (cycles in which the fuel was successfully ignited and combusted), and determines whether the number of ignitions is equal to or smaller than the predetermined value (step S6). Then, when the number of ignitions is equal to or smaller than the predetermined value, returning to step S5, the controller 2 executes the spark ignition of the fuel in the fuel injection period. Meanwhile, when the number of ignitions exceeds the predetermined value, the control processing by the control device of the embodiment ends.

In the embodiment, while the example in which the controller 2 that executed step S5 determines whether the fuel is ignited on the basis of the change in pressure in the cylinder 3a, calculates the consecutive number (number of ignitions) of fuel ignition cycles, and determines whether the number of ignitions is equal to or smaller than the predetermined value has been exemplarily described, the controller 2 may determine whether the fuel is ignited on the basis of the change in crank angle detected by the crank angle detecting part 21, or may determine whether the fuel is ignited on the basis of the change in pressure in the cylinder 3a and the change in crank angle.

In the control device of the embodiment, the controller 2 executes the spark ignition of the fuel in the fuel injection period in which the alcohol-containing fuel is injected into the cylinder 3a when the ambient temperature is equal to or smaller than the predetermined value. For this reason, even when the engine 3 configured to directly inject the alcohol-containing fuel into the cylinder 3a is started under a low temperature environment, good startability is obtained.

In the above-mentioned embodiment, while the case in which step S1 to step S3 are executed in sequence as shown in FIG. 2 has been exemplarily described, the sequence of step S1 to step S3 is not particularly limited.

In addition, in the above-mentioned embodiment, while the case in which the controller 2 determines whether the temperature of the outside air, which is the ambient temperature, and the temperature of the engine water are equal to or smaller than the predetermined value and determines whether the concentration of alcohol in the fuel is equal to or greater than the predetermined value in step S4 has been exemplarily described, the controller may determine whether the ambient temperature is equal to or greater than the predetermined value, and for example, determine whether any one of the temperature of the outside air and the temperature of the engine water is equal to or less than the predetermined value. Accordingly, as shown in FIG. 2, all of steps S1 to S3 may be executed, but it is sufficient to execute at least one of step S1 and step S2, and step S3 does not have to be executed.

In addition, in the above-mentioned embodiment, as shown in FIG. 2, although the case in which step S6 is executed has been exemplarily described, the control processing may be ended without executing step S6. When the control processing is ended without executing step S6, the control processing of the engine 3 shown in FIG. 2 may be repeatedly executed.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A control device for an internal combustion engine, which is a control device for a spark ignition internal combustion engine, configured to directly inject alcohol-containing fuel into a cylinder, the control device comprising:
a controller configured to control an injection timing when the fuel is injected into the cylinder from a fuel injection device and an ignition timing when the fuel in the cylinder is ignited by a spark; and
an ambient temperature detecting part configured to detect an ambient temperature,
wherein the controller executes spark ignition of the fuel in a fuel injection period in which the fuel is injected into the cylinder when the ambient temperature is equal to or smaller than a predetermined value.

2. The control device for an internal combustion engine according to claim 1, wherein the ambient temperature detecting part has:
an outside temperature detecting part configured to detect a temperature of outside air suctioned into the cylinder; and
an engine water temperature detecting part configured to detect a temperature of engine water,
wherein the ambient temperature is the temperature of the outside air and/or the temperature of the engine water.

3. The control device for an internal combustion engine according to claim 1, wherein the controller executes spark ignition of the fuel in the fuel injection period when the ambient temperature is within a range of 5° C. to −40° C.

4. The control device for an internal combustion engine according to claim 1, wherein an alcohol concentration detecting part configured to detect a content of alcohol contained in the fuel is provided, and the controller executes spark ignition of the fuel in the fuel injection period when the concentration of alcohol in the fuel is equal to or greater than a predetermined value.

5. The control device for an internal combustion engine according to claim 4, wherein the controller executes spark ignition of the fuel in the fuel injection period when a concentration of alcohol in the fuel is equal to or greater than 90 volume %.

6. The control device for an internal combustion engine according to claim 1, wherein a crank angle detecting part configured to detect rotation of a crankshaft and output a crank angle signal and a top dead center signal is provided, and the controller injects the fuel into the cylinder from the fuel injection device in a compression stroke.

7. The control device for an internal combustion engine according to claim 1, wherein the controller executes spark ignition of the fuel within ⅓ of a period of retardation in the fuel injection period.

8. The control device for an internal combustion engine according to claim 1, wherein a cylinder pressure detecting part configured to detect a pressure in the cylinder is provided, and
the controller determines whether the fuel has been ignited on the basis of a change in pressure in the cylinder and executes spark ignition of the fuel in the fuel injection period when a consecutive number of the fuel ignition cycles is equal to or smaller than a predetermined value.

9. The control device for an internal combustion engine according to claim 1, wherein a crank angle detecting part configured to detect rotation of a crankshaft and output a crank angle signal is provided, and
the controller determines whether the fuel is ignited on the basis of the change in crank angle, and executes spark ignition of the fuel in the fuel injection period when a consecutive number of the fuel ignition cycles is equal to or smaller than a predetermined value.
